(19) United States
(12) Patent Application Publication
(10) Pub. No.: US 2006/0239119 A1
(43) Pub. Date: Oct. 26, 2006

(54) Multiple projectors for increased resolution receive beam processing of echoing sonars and radars

(75) Inventors: Thomas Jerome Hartka, Annapolis, MD (US); Ernest Allen Arizzi, Annapolis, MD (US)

Correspondence Address: ROTHWELL, FIGG, ERNST & MANBECK, P.C., 1425 K STREET, N.W., SUITE 800, WASHINGTON, DC, 20005, US

(73) Assignee: NORTHROP GRUMMAN CORPORATION, Los Angeles, CA (US)

(21) Appl. No.: 11/073,580

(22) Filed: Mar. 8, 2005

(51) Int. Cl. G01S 15/00

(52) U.S. Cl. 367/87

(57) ABSTRACT

An echoing system includes at least two projectors: a first projector is configured to transmit a first radio frequency signal of a first frequency and a second projector configured to transmit a second radio frequency signal of a second frequency. A plurality of receivers receive reflected radio frequency signals. A phased array beam-former is coupled with the plurality of receivers and configured to amplify and to digitize the received reflected radio frequency signals.

### BACKGROUND OF THE INVENTION

1. Field of the Invention

The present invention is directed to echoing systems such as sonar and radar. More particularly, the present invention is directed to synthetic echoing systems that utilize multiple projectors.

2. Description of the Related Art

Echoing systems, such as radar and sonar are well known. Modern echoing systems often utilize phased array antennas that utilize a plurality of receiving elements (i.e., an array) to receive and process reflected signals. Phased arrays form multiple, independently steered beams from a single echo time history by “phasing” the receive signals such that they coherently add in the desired beam direction.

“Phasing” coefficients are a function of distance, wave speed and frequency. Typically, only the receive phase needs to be adjusted, and not the transmit phase. As a result, multiple beams can be formed from one set of received data using multiple sets of phasing coefficients produced by each single transmission.

Two types of arrays used in echoing systems are real and synthetic phased arrays. Real arrays use a moving array and takes instantaneous images. Synthetic arrays utilize a stationary array (with a moving vehicle) and create an image by combining or synthesizing the measurement over time. The resolution of a real aperture phased array and the speed at which a synthetic aperture array can be moved are typically considered to be “aperture limited.” The resolution of the real phased array can be represented by the formula, R=λ*D/A, where R is the resolution, λis wavelength, D is field range from face of receive array, and A is the aperture size, which in a real array equals the length of the receive array. The units of A and D and the units of A and R must be the same. For example, A and A can be in inches and R and D can be in feet. The maximum speed of a synthetic array can be represented by the formula S=A*V_{OS}/D, where V_{OS} is the velocity of sound in the medium that the echoing system is being used (e.g., fresh or salt water for sonar). The resolution of both a real array and a synthetic array are the same when the phase center span is used as the aperture length, and the target is in the far field of the projector. As a result, the performance of an echoing system is limited by the space available for the receive array or the quality (i.e., cost) of the individual receive elements and the processing electronics associated with them.

The effective pattern of an echoing system is the product of its transmit pattern and receive patterns. FIG. 1a shows the composite beam pattern of a real array echoing system 100 having a single projector 102 and a receive array 104 made up of five individual receive elements 104a-e. The line 106 represents the transmit energy pattern of the device, the main lobe 108 is used for creating an image, and the outer lobes 110a-g are essentially ignored. The receive pattern represents all the receive elements summed together in parallel. The X's represent the geometric spatial mean between transmit and receive elements and is referred to as a phase centers. One skilled in the art will recognize that the phase centers are illustrative and are not accurately represented in the figures.

FIG. 1b shows the composite receive patterns of a real binaural array echoing system 106b. In a real binaural echoing system two projectors 102a, 102b transmit energy in the same bandwidth to produce an interference pattern. The 3 dB beam-width of the two-way pattern of the array shown in FIG. 1b is approximately half as wide as the beam-width of the array shown in FIG. 1a. That is, the main lobe 108 that is measure, the portion over the 3 dB line, is more refined in the binaural array and therefore, increases resolution. This difference in beam-width results from interference between the two transmissions in the same bandwidth. Systems similar to that illustrated by FIG. 1b are inherently limited in the number of beams they can form from a single ping because the transmit pattern cannot be changed during the receive time of the ping.

It is well known that the 3 dB beam-width of a synthetic phased array is half that of a real array with the same effective receive array length in space. This can be proven mathematically, and it has been demonstrated in fielded systems. In order to achieve the resolution of a fully populated array, rather than a sparse array which suffers from gaps between the phase centers, the real aperture of a conventional synthetic array can only be moved one half of the array length 212 between pings as shown in FIG. 2. This is normally pictorially justified by an appeal to analysis by phase centers. The phase center of 204 a spatially separated transmitter and receiver pair is located at the geometric mean between the respective transmitter 208 and receiver 206, and is the position of an equivalent co-located transmit/receive pair that gives approximately the same performance as the actual transmit/receive positions. For synthetic arrays constructed from many pings (and for real array beams near normal to the array), these phase centers can be used to calculate beam patterns to a high degree of accuracy. Using the concept of phase centers, it is seen why the real aperture of the synthetic array can only be moved one half the real array length; any larger movement would leave a gap in the continuous set of synthetic array phase centers 210.

As a result, the speed of a vehicle bearing a synthetic echoing system is limited. That is, if you must ping every half of the array, then the speed of the vehicle is limited to the speed of the electronics and the size of the array. This is exacerbated when a system is using a long range because the array can only travel a short distance in the long time it takes to receive the reflected signal.

There have been attempts to improve upon synthetic echoing systems. U.S. Pat. No. 6,594,200, the entire contents of which are incorporated herein by reference, describes a synthetic aperture sonars (SAS) system. However, it has a number of flaws.

Up-chirps and down-chirps are not separable in an imaging sonar: the relative amplitude of summed up-chirp and down-chirp reverberation is unchanged by passing such a signal through either the up-chirp or down-chirp's Matched Filter.

Additionally, displaced phase centers (DPC) “fluctuation correction” cannot be performed by cross-correlating two reverberation signals that were obtained at different frequencies. The amplitude and apparent delay of reverberation is a function of frequency.

U.S. Pat. No. 6,594,200 envisions incoherent summation of the two received signals. This reduces spot-noise and is equivalent to multi-look processing as claimed, but this does not result in a fully populated synthetic array. Each image S(a) and S(b) is effectively from 50% populated arrays, with all the known problems of sparsely populated arrays.

Thus, there is a need for new and improved echoing systems and methods.

### SUMMARY OF THE INVENTION

According to one embodiment of the present invention a high speed synthetic aperture echoing system is provided. The system includes: (a) a first projector is configured to transmit a first radio frequency signal of a first frequency and a second projector is configured to transmit a second radio frequency signal of a second frequency; (b) a receiver capable of receiving reflected radio frequency signals; and (c) phased array beam-former which amplifies and digitizes the received reflected radio frequency signals.

The present invention is capable of increasing the effective number of receive elements in a multi-beam phased array echoing system by the use of spatially separated simultaneous transmissions centered at different frequencies. Practical uses of this novel system geometry and receive processing include increasing the resolution of a real multi-beam phased array and increasing the usable speed of a synthetic array in both sonars and radars.

By separating the frequency of the transmissions, the present invention is capable of avoiding the problem with chirps that overlap in frequency by using chirps that do not overlap in frequency.

The present invention is capable of avoiding the prior art problems with DPC by alternating the frequency transmitted for the two projectors on each ping. This results in DPC being performed with the identical waveforms from each ping pair.

The present invention has the advantage that it may be implemented with one normal multi-element receive array and multiple projectors.

The present invention envisions coherent summation of the received signals from each projector. This results in a fully populated synthetic array and thus maintains the same performance as a single projector synthetic array, but it can be moved the whole vernier array length between pings.

Further applications and advantages of various embodiments of the present invention are discussed below with reference to the drawing figures.

### BRIEF DESCRIPTION OF THE DRAWINGS

FIG. 1a is a diagram showing the composite beam pattern of a conventional system;

FIG. 1b is a diagram showing the composite beam pattern of a binaural system with two transmitters of the same frequency;

FIG. 2 is a diagram showing a movement limitation of one half the array length per ping of a conventional synthetic array echoing system's

FIG. 3a is a block diagram showing data acquisition scheme and summation of complex signals contributed by each transmitter frequency to form a beam pattern;

FIG. 3b is a diagram showing a movement limitation of one array length per ping of a high speed synthetic array echoing system;

FIG. 4 is a computer generated model showing a physical configuration of the present invention;

FIG. 5 is a diagram showing signal time history spectra;

FIG. 6 is a diagram showing theoretical single frequency beam patterns;

FIGS. 7A-D are diagrams showing duel frequency echo mixed with source fundamentals;

FIGS. 8A-D are diagrams showing an example spectrum of mixed down signals; fundamental energy is centered about DC;

FIG. 9 is a diagram showing the resultant beam pattern is approximately half the 3 dB beam-width of either frequency beam pattern; and

FIG. 10 is a diagram showing the narrow composite beam can be steered and shaded in the usual manner.

### DETAILED DESCRIPTION OF THE PREFERRED EMBODIMENTS

According to an embodiment of the present invention, a high speed synthetic array echoing system includes multiple projectors operating at different frequencies combined with an array receiver and standard phased array beam-former. As a result, a multi-beam phased array echoing system is provided with double or more the resolution of a single frequency system with a receive array of the same size.

According to an embodiment of the present invention, an echoing system is provided that is capable of simultaneous transmission from multiple transmitters, each operating in a different frequency band. Multiple local oscillator, mixer based receivers may be provided to band shift each receive element signal multiple times so that each transmitted frequency band is simultaneously band shifted to the same frequency band with filters to attenuate signals outside a desired common band. A delay and/or phase shift section may be provided to adjust the phase and/or the delay of each frequency channel of each receive element so that all transmitted signals echoed from a particular point in space are coherent. A summing stage may be provided that coherently adds all frequency channels of all receive elements together for each point in space that is desired to be interrogated by the system. Two frequency bands of transmission may be alternated between the forward most and aft most projectors when this invention is applied to phased arrays that use displaced phase centers (DPC).

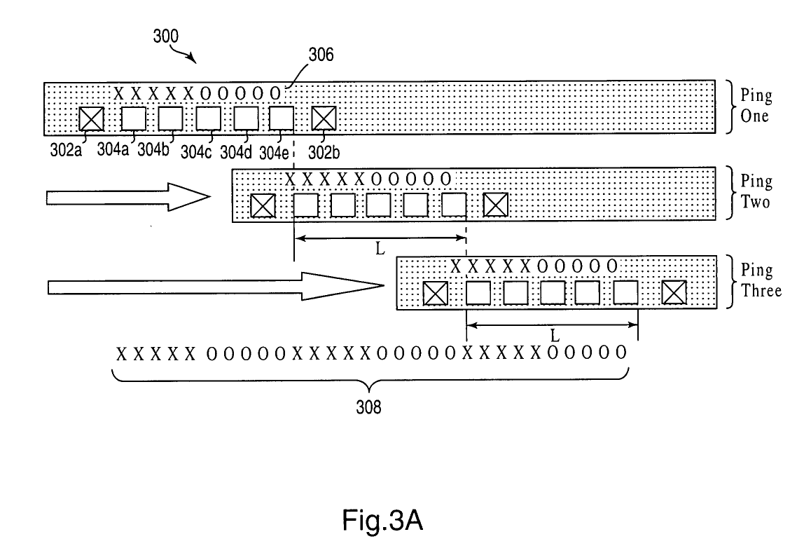

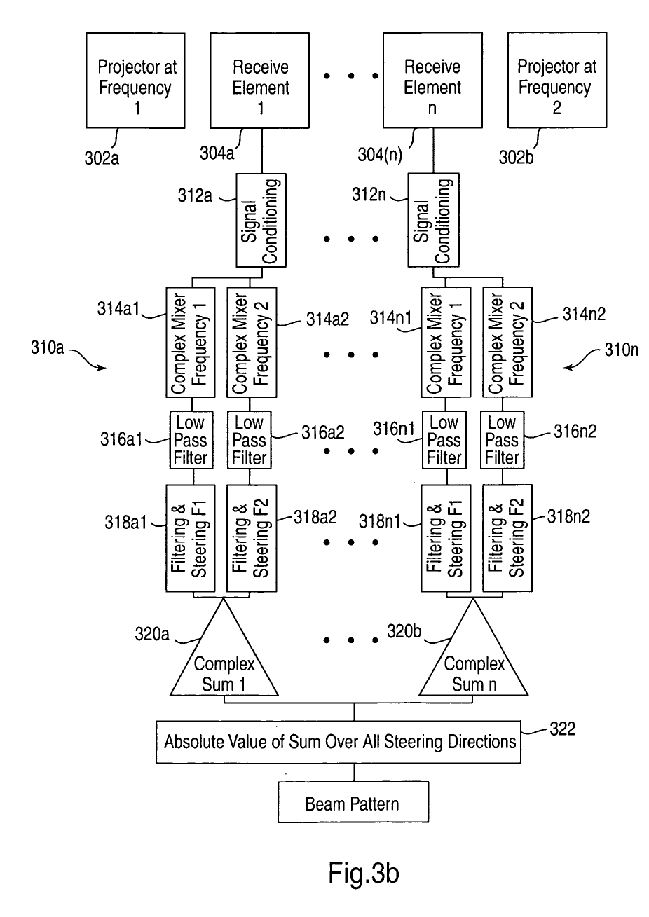

FIG. 3a illustrates a high speed synthetic array echoing system according to an embodiment of the present invention. This exemplary system 300 contains at least two projectors 302a,b configured to transmit radio frequency signals in different frequency bandwidths. These signals are reflected off of objects within the range of the echoing system, and these reflected signals are received by at least one of an array of receive element(s) 304a-e. Phase centers 306 for each projector 302a, b are shown by X's representing the phase centers for projector 302a and O's representing the phase centers for projector 302b. By projecting in two separate frequencies f1 and f2, interference is eliminated and a larger set of phase center is generated. That is, an additional set of phase centers are provided (the O's) which, in this example, double the size of the combined phase center.

For Sonars, frequencies f1 and f2 are preferably selected to be in the range of 50 kHz-1 MHz but can be any frequency, and one having skill in the art will recognize that the present invention may be scaled to handle any frequency. Attenuation is considered to be the limiting factor for high frequency, while resolution is considered to be the limiting factor for the low frequency. Most conventional sonar systems, for example, operate in the hundred kilohertz frequency range. The two frequencies f1 and f2 should be selected to separate the bandwidth of each pulse. Ideally, the full bandwidth would be separated between f1 and f2. Therefore, for a bandwidth of 30 kHz, f1>f2+30 kHz. In the examples below, f1=100 kHz and f2=103 kHz, for a separation of only 3 kHz. This example uses a smaller separation (3 kHz) bandwidth for computational efficiency, but the principle of the invention remains the same for larger bandwidths and for different frequencies.

The separation bandwidth between the two frequencies F1 and F2 is also referred to as the “guard band.” The guard band is preferably large enough to prevent cross-talk between the received, reflected signals. One skilled in the art will understand that the upper limit of the guard band will be practically limited by the system design and quality of components.

As shown, the phase centers span a full array length. A continuous array of phase centers can be generated by pinging every array length rather than half of the array length. Therefore, the present invention can double the performance of prior art.

Further, additional projectors (not shown) could be added to the array to further increase performance. Each additional projector creates an additional set of phase centers per ping, which produces a longer array segment per ping. Thus, the vehicle can travel a longer distance in the time it takes to ping. The number of additional transmitters will be limited by the bandwidth of the receive elements.

FIG. 3b is a block diagram of the high speed synthetic array echoing system of FIG. 3a, according to an embodiment of present invention. Two projectors 302a, b transmit RF signals f1 and f2, which reflect off of objects, and the reflected signals are received at receive elements 304a-304n (in the case of FIG. 3a, only five (n=5) receive elements are utilized, 304a-e). The received reflected signals are then processed through a number of different processing components to eventually form the beam pattern. Although only two receive elements 304a, 304n and process paths 310a, 310n are shown, one skilled in the art would readily understand that each receive element 304 may have a separate processing path in parallel with those of the other receive elements 304. As shown, within each processing path 310, separate branches are provided for each frequency (f1, f2). If additional transmitters are provided, additional branches can be provided for each additional frequency.

When a signal is received at a receive element 304, it is first conditioned by a signal conditioner 312 (a-n). The output of the signal conditioner is coupled with the input of two complex mixers 314(a1,a2-n1, n2), a first mixer processing frequency f1 and a second mixer processing frequency f2. The mixers 314 translate and amplify the radio frequency signals to an amplified intermediate frequency. The output of each mixer 314 is coupled with a low pass filter 316(a1,a2-n1, n2) to isolate the signals from noise and interference. The output of the band pass filters are input into filtering and steering units 318(a1,a2-n1, n2), which further filter the received signal and adjust the steering of the signal. The processed signals (f1, f2) for each receive element is then compiled by a complex sum unit 320(a1,a2-n1, n2), essential summing the phase centers for each frequency f1, f2 projected.

All of the summed signals for each receive element are further summed with each other by final sum unit 322. This final sum output from the final sum unit 322 is the system output for a particular field point and a particular array position and can be used to create a display, such as a waterfall display. A beam pattern generator 324 can be used to synthesize a beam pattern by plotting a succession of field points for a fixed array.

By using the present invention, the array is allowed to travel approximately twice as fast as one that utilizes a single frequency array of the same size, provided that the high speed system contains two projectors. More than two projectors can be used to further increase the speed at which the array may travel. For example, the array of a high speed synthetic array echoing system with four projectors could be moved at four times the speed of a conventional echoing system with one projector. The limit on the number of projectors that can be used in a high speed synthetic array echoing system is based, inter alia, on the receive bandwidth of the receive elements.

A computer model, along with figures was generated to demonstrate the novel beam forming technique of the present invention to illustrate the improved resolution beam pattern. Element signals were generated for two transmitters at different frequencies and separate locations. Spatially sampled receive aperture data was generated for a number of receive elements. The array data was summed every degree for field points in an arc in the far field of the array.

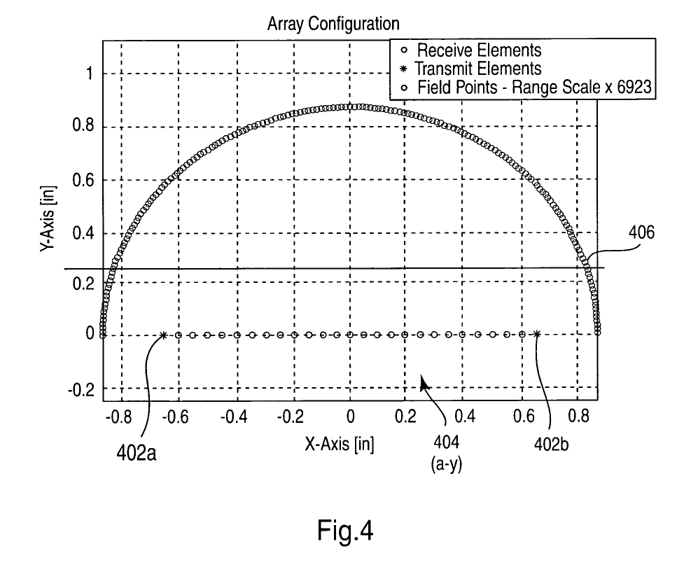

FIG. 4 shows the exemplary configuration of the elements and field points used for modeling. System 400 includes first and second projectors 402a, 402b and a linear array of receive elements 404a-404y (n, n=25). The arc 406 represents the infinite number of points in the far field of the array.

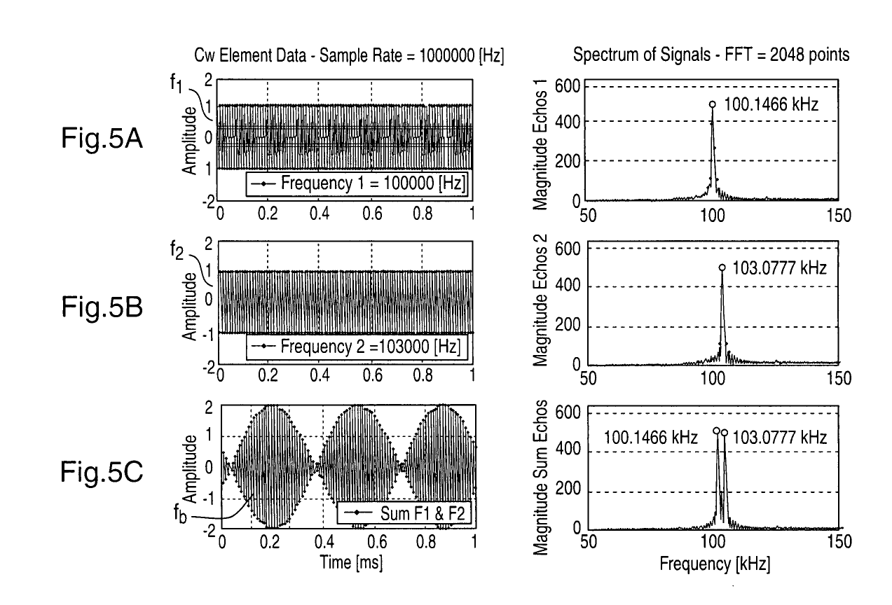

In this example, the first projector 402a transmits a 100 kHz sine wave, and the second projector 402b transmits a 103 kHz sine wave. These highly sampled signals and spectra are shown in FIGS. 5a and 5b respectively. The signals f₁ and f₂ will combine in the medium and will arrive at each receive element 404(n) with a unique phase producing a beat frequency f₆ as seen in FIG. 5c.

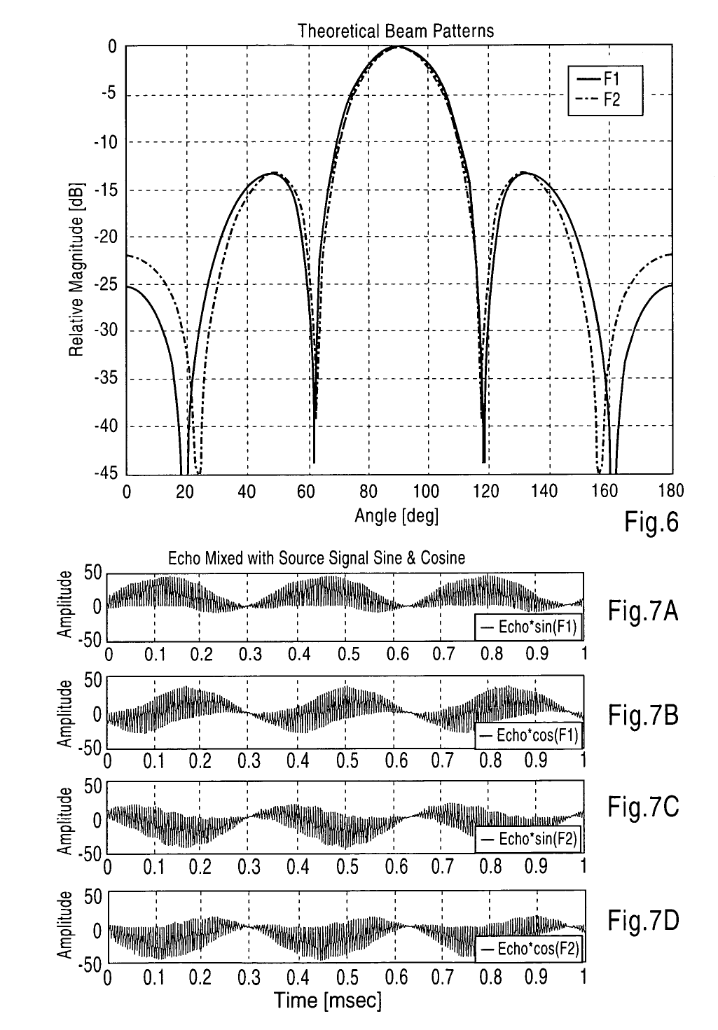

Examining each frequency as an independent transmitter and receive array, the typical summation of the elements over angle yields the beam patterns shown in FIG. 6. As expected the higher frequency transmission gives a slightly narrower beam f₂ when compared to the beam yielded by the lower frequency transmission f₁. Each frequency transmitted by a projector generates a phase centers corresponding to each receive element. A phase center is the geometric center between the location of the projector and the location of the individual receive element receiving the reflected radio frequency signal. Because each projector has a different location and a unique radio frequency signal, multiple sets of independent phase centers are generated.

The element data, collected by each individual receive element, is multiplied by the sine and cosine of the center frequencies of the projectors to beat the respective fundamental radio frequency signals to baseband. FIGS. 7a-d illustrates the mixed radio frequency signals before they are combined to build the complex beat radio frequency signal. The energy due to each fundamental transmitter frequency is isolated from the mixed down signals by low pass filtering. The respective 1's and Q's can then be combined to rebuild the complex signals corresponding to each transmitter frequency.

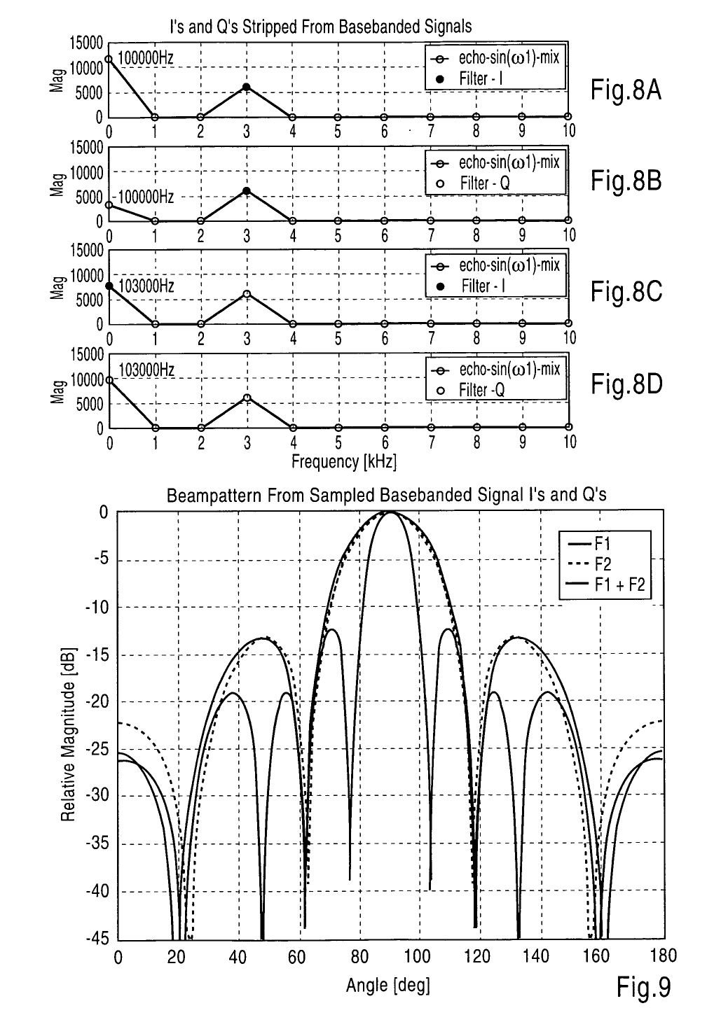

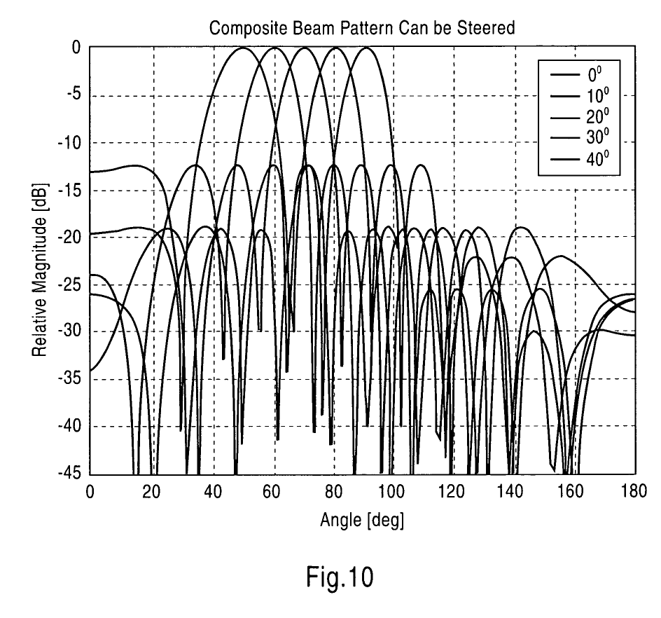

FIGS. 8a-d show the spectrum of the sampled and mixed down signals. The complex signals can be further summed in each field direction to arrive at the final beam pattern. For the normally looking case, FIG. 9 shows that the 3 dB beam-width of the summed beam pattern f, +f₂ is half that of the beam formed of each frequency independently f₁, f₂. Note that the first side lobes are acceptably low.

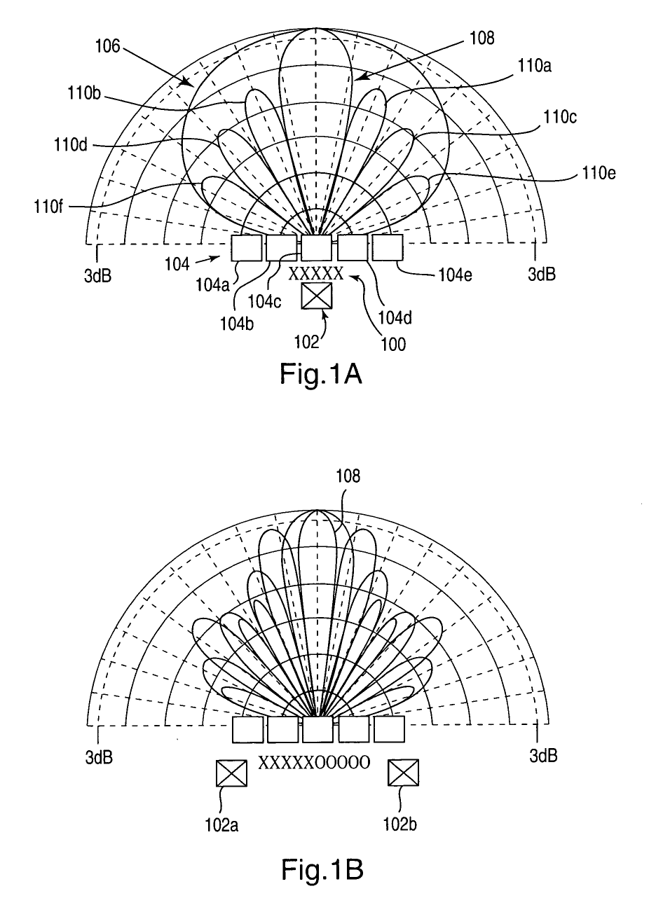

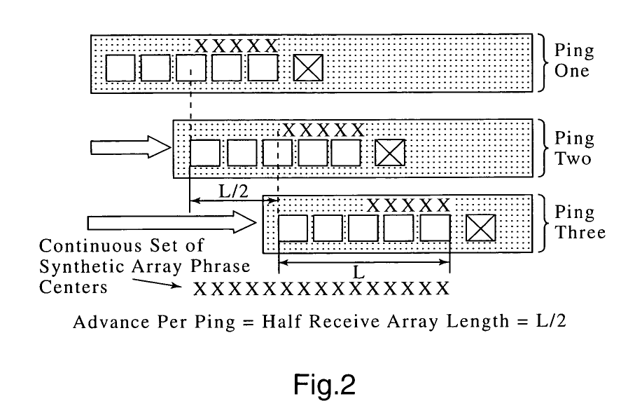

The beams formed utilizing the technique described in this disclosure can be focused steered and shaded in the usual ways. The capability for full steering is an improvement over the conventional system illustrated in FIGS. 1a and 1b can only be steered to the peaks of the transmit pattern and not the nulls, as there is no energy present at the nulls. FIG. 10 illustrates that the narrow beam formed using the technique described in this disclosure can be steered to sum coherently in a given direction with usual main lobe and side lobe and grating lobe behavior. Conventional amplitude shading techniques to reduce side lobe level also work in conjunction with this beam forming technique. Hence, the beamforming technique described herein does not preclude the use of typical signal processing techniques. An additional feature of this invention is the ability to perform the DPC (Displaced Phase Center) calculation often used in synthetic aperture Sonars with the same bottom interrogation waveform.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

Further, many non-limiting advantages over the prior art will be recognized. For example, there exists a problem with prior art Sonars with “up-chirps” and “down-chirps” being not separable in imaging sonar when they over-lap: i.e., the relative amplitude of summed up-chirp and down-chirp reverberation is unchanged by passing such a signal through either the up-chirp or the down-chirp's matched filter. The present invention is capable of avoiding this problem by the use of chirps that do not overlap in frequency.

The prior art also has difficulty with dynamic phase correction (DPC), which cannot be performed by cross-correlating two reverberation signals that were obtained at different frequencies. The amplitude and apparent delay of reverberation is a function of frequency. The present invention is capable of avoiding problems with the prior art

We claim:

1. A synthetic array echoing system comprising:
at least two projectors, including a first projector configured to transmit a first radio frequency signal of a first frequency and a second projector configured to transmit a second radio frequency signal of a second frequency;
a plurality of receivers configured to receive reflected radio frequency signals; and
a phased array beam-former coupled with said plurality of receivers and configured to amplify and to digitize the received reflected radio frequency signals.

2. The echoing system according to claim 1, wherein said at least two projectors are capable of simultaneous transmission.

3. The echoing system according to claim 1, wherein said first frequency is within a frequency band different than that of said second frequency.

4. The echoing system according to claim 1, wherein the first projector and said second projector transmit radio frequency signals in an alternating arrangement between said first and second frequencies.

5. The echoing system of claim 1, wherein said first frequency is separated from said second frequency by a guard band being large enough in bandwidth to prevent cross-talk from occurring between received reflected radio frequency signals.

6. The echoing system according to claim 4, wherein said transmitted radio frequency signals generate continuous phase centers spanning a length approximately equal to a length of said synthetic array.

7. A synthetic echoing method comprising steps of:
a. providing an array of receive elements configured to receive RF signals;
b. simultaneously transmitting first and second RF signals from positions on first and second sides of said array, said first RF signal having a frequency different from said second RF signal;
c. at each receive element of said array, receiving first and second reflected RF signals from the transmitted first and second RF signals;
d. band shifting each receive elements received signal so that each said first and second RF signals are simultaneously band shifted to the same frequency band;
e. summing each signal for each receive element; and
f. outputting the result of step e.

8. The method of claim 7 further comprising a step of alternating the frequency of said first and second RF signals.

9. The method of claim 7 further comprising a step of phase shifting each signal such that each signal echoed from a particular point in space are coherent.

10. The method of claim 7 further comprising a step of filtering attenuated signals outside a desired common band.

11. The method of claim 7, wherein said a guard band being large enough in bandwidth to prevent cross-talk between receive reflected radio frequency signals

12. A synthetic array echoing system comprising:
projector means for transmitting a first radio frequency signal of a first frequency and a second radio frequency signal of a second frequency;
receiver means for receiving reflected radio frequency signals; and
beam-former means for amplifying and to digitizing the received reflected radio frequency signals.

13. The echoing system according to claim 11, wherein said projector means include at least two projector units capable of simultaneous transmission.

14. The echoing system according to claim 11, wherein said first frequency is within a frequency band different than that of said second frequency.

15. The echoing system according to claim 12, wherein a first projector and a second projector of said projector means transmit radio frequency signals in an alternating arrangement between said first and second frequencies.

16. The echoing system of claim 11, wherein said first frequency is greater than said second frequency by an amount large enough to prevent cross-talk from occurring between the received reflected radio frequency signals.

17. The echoing system according to claim 14, wherein said transmitted radio frequency signals generate continuous phase centers spanning a length approximately equal to a length of said synthetic array.
